(19) United States
(12) Patent Application Publication
(10) Pub. No.: US 2022/0300547 A1
(43) Pub. Date: Sep. 22, 2022

(54) System and Method for Generating Defect Identifiers

(71) Applicant: EMC IP Holding Company, LLC, Hopkinton, MA (US)

(72) Inventor: Edward Guy Smith, Milford, NH (US)

(21) Appl. No.: 17/206,251

(22) Filed: Mar. 19, 2021

(51) Int. Cl. G06F 16/35; G06F 16/33

(52) U.S. Cl. CPC G06F 16/355; G06F 16/3331

(57) ABSTRACT

A method, computer program product, and computing system for receiving one or more defect characteristics associated with one or more computing device-related defects. Information associated with the one or more defect characteristics may be extracted from unstructured defect data based upon, at least in part, the one or more defect characteristics. A defect identifier for the one or more defect characteristics may be generated based upon, at least in part, the extracted information associated with the one or more defect characteristics.

### BACKGROUND

Storing and safeguarding electronic content may be beneficial in modern business and elsewhere. Accordingly, various methodologies may be employed to protect and distribute such electronic content.

As storage systems are utilized to perform various tasks and operations, software defects and failures may occur. However, diagnosing software failures can be challenging, time consuming, and requires highly skilled engineers whether in-house during product development or triaging a customer issue. When processing these defects, duplicate defects are often found, wasting valuable engineering time triaging the failures. In addition, defects found in the field often affect multiple customers and triaging each issue manually is inefficient. The turnaround time between a defect being discovered and a fix being delivered generally depends on how quickly the defect is provided to the right individuals. Defect data collected from storage systems is largely unstructured, making it difficult to use machine learning techniques and other artificial intelligence techniques to assist in defect identification, de-duplication, and routing of the defect to the right individuals or team.

### SUMMARY OF DISCLOSURE

In one example implementation, a computer-implemented method executed on a computing device may include, but is not limited to, receiving one or more defect characteristics associated with one or more computing device-related defects. Information associated with the one or more defect characteristics may be extracted from unstructured defect data based upon, at least in part, the one or more defect characteristics. A defect identifier for the one or more defect characteristics may be generated based upon, at least in part, the extracted information associated with the one or more defect characteristics.

One or more of the following example features may be included. Receiving the one or more defect characteristics include receiving a defect type and a reporting component associated with the one or more computing device-related defects. Extracting the information associated with the one or more defect characteristics from the unstructured defect data may include: identifying one or more source files within the unstructured defect data based upon, at least in part, the one or more defect characteristics; identifying one or more defect characteristic field extraction expressions based upon, at least in part, the one or more defect characteristics; and extracting, via the one or more defect characteristic field extraction expressions, one or more defect characteristic fields associated with the one or more defect characteristics. Extracting the information associated with the one or more defect characteristics from the unstructured defect data may include: identifying one or more defect characteristic field value extraction expressions based upon, at least in part, the one or more defect characteristic fields; and extracting, via the one or more defect characteristic field value extraction expressions, one or more defect characteristic field values associated with the one or more defect characteristic fields. Generating the defect identifier for the one or more defect characteristics may include generating the defect identifier with the one or more defect characteristic fields and the one or more data characteristic field values extracted from the unstructured defect data. It may be determined whether the one or more defect identifiers are duplicative of one or more existing defect identifiers of a defect identifier database. In response to determining that the one or more defect identifiers are not duplicative of the one or more existing defect identifiers, the one or more defect identifiers may be assigned to at least one defect resolution resource of a plurality of defect resolution resources.

In another example implementation, a computer program product resides on a computer readable medium that has a plurality of instructions stored on it. When executed by a processor, the instructions cause the processor to perform operations that may include, but are not limited to, receiving one or more defect characteristics associated with one or more computing device-related defects. Information associated with the one or more defect characteristics may be extracted from unstructured defect data based upon, at least in part, the one or more defect characteristics. A defect identifier for the one or more defect characteristics may be generated based upon, at least in part, the extracted information associated with the one or more defect characteristics.

One or more of the following example features may be included. Receiving the one or more defect characteristics include receiving a defect type and a reporting component associated with the one or more computing device-related defects. Extracting the information associated with the one or more defect characteristics from the unstructured defect data may include: identifying one or more source files within the unstructured defect data based upon, at least in part, the one or more defect characteristics; identifying one or more defect characteristic field extraction expressions based upon, at least in part, the one or more defect characteristics; and extracting, via the one or more defect characteristic field extraction expressions, one or more defect characteristic fields associated with the one or more defect characteristics. Extracting the information associated with the one or more defect characteristics from the unstructured defect data may include: identifying one or more defect characteristic field value extraction expressions based upon, at least in part, the one or more defect characteristic fields; and extracting, via the one or more defect characteristic field value extraction expressions, one or more defect characteristic field values associated with the one or more defect characteristic fields. Generating the defect identifier for the one or more defect characteristics may include generating the defect identifier with the one or more defect characteristic fields and the one or more data characteristic field values extracted from the unstructured defect data. It may be determined whether the one or more defect identifiers are duplicative of one or more existing defect identifiers of a defect identifier database. In response to determining that the one or more defect identifiers are not duplicative of the one or more existing defect identifiers, the one or more defect identifiers may be assigned to at least one defect resolution resource of a plurality of defect resolution resources.

In another example implementation, a computing system includes at least one processor and at least one memory architecture coupled with the at least one processor, wherein the at least one processor is configured to receive one or more defect characteristics associated with one or more computing device-related defects. The at least one processor may be further configured to extract information associated with the one or more defect characteristics from unstructured defect data based upon, at least in part, the one or more defect characteristics. The at least one processor may be further configured to generate a defect identifier for the one or more defect characteristics based upon, at least in part, the extracted information associated with the one or more defect characteristics.

One or more of the following example features may be included. Receiving the one or more defect characteristics include receiving a defect type and a reporting component associated with the one or more computing device-related defects. Extracting the information associated with the one or more defect characteristics from the unstructured defect data may include: identifying one or more source files within the unstructured defect data based upon, at least in part, the one or more defect characteristics; identifying one or more defect characteristic field extraction expressions based upon, at least in part, the one or more defect characteristics; and extracting, via the one or more defect characteristic field extraction expressions, one or more defect characteristic fields associated with the one or more defect characteristics. Extracting the information associated with the one or more defect characteristics from the unstructured defect data may include: identifying one or more defect characteristic field value extraction expressions based upon, at least in part, the one or more defect characteristic fields; and extracting, via the one or more defect characteristic field value extraction expressions, one or more defect characteristic field values associated with the one or more defect characteristic fields. Generating the defect identifier for the one or more defect characteristics may include generating the defect identifier with the one or more defect characteristic fields and the one or more data characteristic field values extracted from the unstructured defect data. It may be determined whether the one or more defect identifiers are duplicative of one or more existing defect identifiers of a defect identifier database. In response to determining that the one or more defect identifiers are not duplicative of the one or more existing defect identifiers, the one or more defect identifiers may be assigned to at least one defect resolution resource of a plurality of defect resolution resources.

The details of one or more example implementations are set forth in the accompanying drawings and the description below. Other possible example features and/or possible example advantages will become apparent from the description, the drawings, and the claims. Some implementations may not have those possible example features and/or possible example advantages, and such possible example features and/or possible example advantages may not necessarily be required of some implementations.

### BRIEF DESCRIPTION OF THE DRAWINGS

FIG. 1 is an example diagrammatic view of a storage system and a defect identifier generation process coupled to a distributed computing network according to one or more example implementations of the disclosure;

FIG. 2 is an example diagrammatic view of the storage system of FIG. 1 according to one or more example implementations of the disclosure;

FIG. 3 is an example flowchart of defect identifier generation process according to one or more example implementations of the disclosure;

FIG. 4 is an example diagrammatic view of the storage system of FIG. 1 according to one or more example implementations of the disclosure; and

FIG. 5 is an example defect identifier generated according to one or more example implementations of the disclosure.

Like reference symbols in the various drawings indicate like elements.

### DETAILED DESCRIPTION

### System Overview:

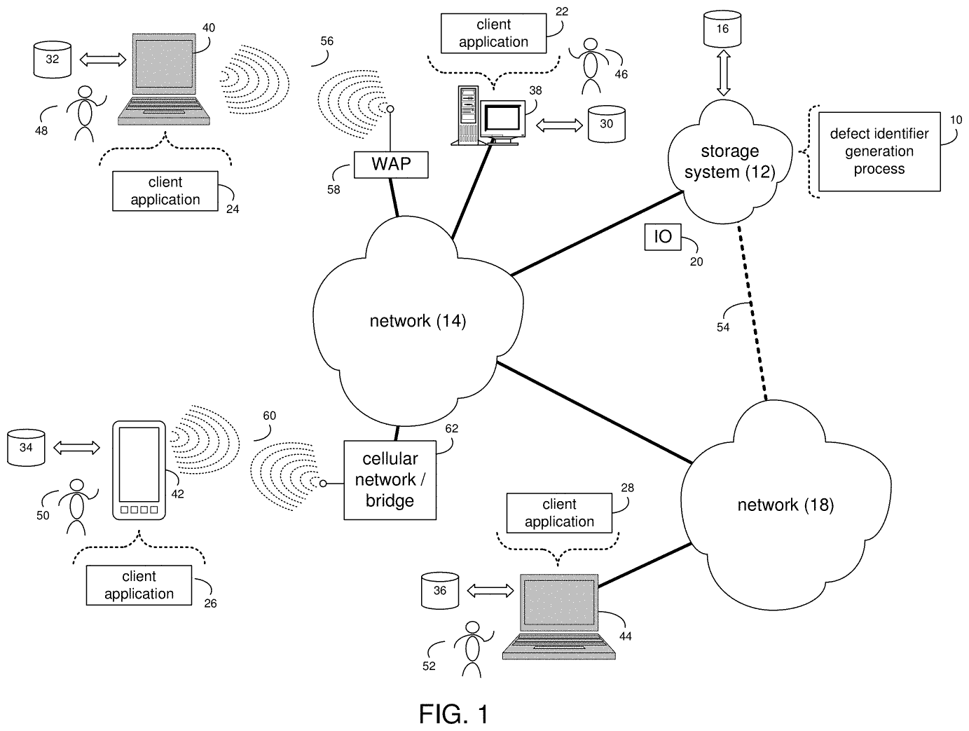

Referring to FIG. 1, there is shown defect identifier generation process 10 that may reside on and may be executed by storage system 12, which may be connected to network 14 (e.g., the Internet or a local area network). Examples of storage system 12 may include, but are not limited to: a Network Attached Storage (NAS) system, a Storage Area Network (SAN), a personal computer with a memory system, a server computer with a memory system, and a cloud-based device with a memory system.

As is known in the art, a SAN may include one or more of a personal computer, a server computer, a series of server computers, a mini computer, a mainframe computer, a RAID device and a NAS system. The various components of storage system 12 may execute one or more operating systems, examples of which may include but are not limited to: Microsoft® Windows®; Mac® OS X®; Red Hat® Linux®, Windows® Mobile, Chrome OS, Blackberry OS, Fire OS, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

The instruction sets and subroutines of defect identifier generation process 10, which may be stored on storage device 16 included within storage system 12, may be executed by one or more processors (not shown) and one or more memory architectures (not shown) included within storage system 12. Storage device 16 may include but is not limited to: a hard disk drive; a tape drive; an optical drive; a RAID device; a random access memory (RAM); a read-only memory (ROM); and all forms of flash memory storage devices. Additionally/alternatively, some portions of the instruction sets and subroutines of defect identifier generation process 10 may be stored on storage devices (and/or executed by processors and memory architectures) that are external to storage system 12.

Network 14 may be connected to one or more secondary networks (e.g., network 18), examples of which may include but are not limited to: a local area network; a wide area network; or an intranet, for example.

Various IO requests (e.g. IO request 20) may be sent from client applications 22, 24, 26, 28 to storage system 12. Examples of IO request 20 may include but are not limited to data write requests (e.g., a request that content be written to storage system 12) and data read requests (e.g., a request that content be read from storage system 12).

The instruction sets and subroutines of client applications 22, 24, 26, 28, which may be stored on storage devices 30, 32, 34, 36 (respectively) coupled to client electronic devices 38, 40, 42, 44 (respectively), may be executed by one or more processors (not shown) and one or more memory architectures (not shown) incorporated into client electronic devices 38, 40, 42, 44 (respectively). Storage devices 30, 32, 34, 36 may include but are not limited to: hard disk drives; tape drives; optical drives; RAID devices; random access memories (RAM); read-only memories (ROM), and all forms of flash memory storage devices. Examples of client electronic devices 38, 40, 42, 44 may include, but are not limited to, personal computer 38, laptop computer 40, smartphone 42, notebook computer 44, a server (not shown), a data-enabled, cellular telephone (not shown), and a dedicated network device (not shown).

Users 46, 48, 50, 52 may access storage system 12 directly through network 14 or through secondary network 18. Further, storage system 12 may be connected to network 14 through secondary network 18, as illustrated with link line 54.

The various client electronic devices may be directly or indirectly coupled to network 14 (or network 18). For example, personal computer 38 is shown directly coupled to network 14 via a hardwired network connection. Further, notebook computer 44 is shown directly coupled to network 18 via a hardwired network connection. Laptop computer 40 is shown wirelessly coupled to network 14 via wireless communication channel 56 established between laptop computer 40 and wireless access point (e.g., WAP) 58, which is shown directly coupled to network 14. WAP 58 may be, for example, an IEEE 802.11a, 802.11b, 802.11g, 802.11n, Wi-Fi, and/or Bluetooth device that is capable of establishing wireless communication channel 56 between laptop computer 40 and WAP 58. Smartphone 42 is shown wirelessly coupled to network 14 via wireless communication channel 60 established between smartphone 42 and cellular network/bridge 62, which is shown directly coupled to network 14.

Client electronic devices 38, 40, 42, 44 may each execute an operating system, examples of which may include but are not limited to Microsoft® Windows®; Mac® OS X®; Red Hat® Linux®, Windows® Mobile, Chrome OS, Blackberry OS, Fire OS, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

In some implementations, as will be discussed below in greater detail, a defect identifier generation process, such as defect identifier generation process 10 of FIG. 1, may include but is not limited to, receiving one or more defect characteristics associated with one or more computing device-related defects. Information associated with the one or more defect characteristics may be extracted from unstructured defect data based upon, at least in part, the one or more defect characteristics. A defect identifier for the one or more defect characteristics may be generated based upon, at least in part, the extracted information associated with the one or more defect characteristics.

For example purposes only, storage system 12 will be described as being a network-based storage system that includes a plurality of electro-mechanical backend storage devices. However, this is for example purposes only and is not intended to be a limitation of this disclosure, as other configurations are possible and are considered to be within the scope of this disclosure.

### The Storage System:

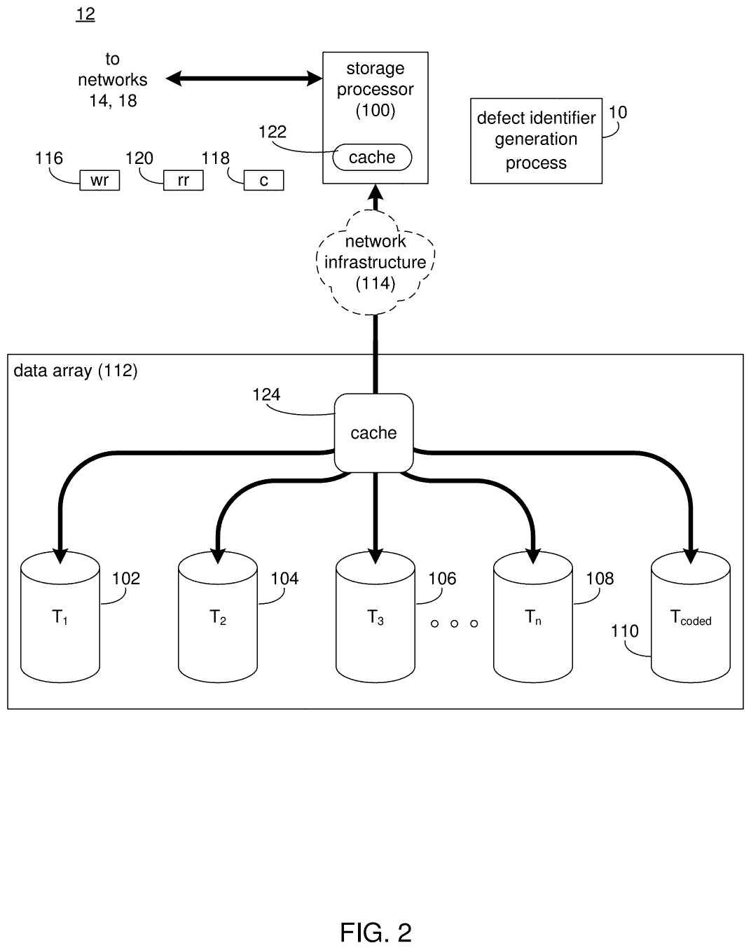

Referring also to FIG. 2, storage system 12 may include storage processor 100 and a plurality of storage targets T 1-n (e.g., storage targets 102, 104, 106, 108). Storage targets 102, 104, 106, 108 may be configured to provide various levels of performance and/or high availability. For example, one or more of storage targets 102, 104, 106, 108 may be configured as a RAID 0 array, in which data is striped across storage targets. By striping data across a plurality of storage targets, improved performance may be realized. However, RAID 0 arrays do not provide a level of high availability. Accordingly, one or more of storage targets 102, 104, 106, 108 may be configured as a RAID 1 array, in which data is mirrored between storage targets. By mirroring data between storage targets, a level of high availability is achieved as multiple copies of the data are stored within storage system 12.

While storage targets 102, 104, 106, 108 are discussed above as being configured in a RAID 0 or RAID 1 array, this is for example purposes only and is not intended to be a limitation of this disclosure, as other configurations are possible. For example, storage targets 102, 104, 106, 108 may be configured as a RAID 3, RAID 4, RAID 5 or RAID 6 array.

While in this particular example, storage system 12 is shown to include four storage targets (e.g. storage targets 102, 104, 106, 108), this is for example purposes only and is not intended to be a limitation of this disclosure. Specifically, the actual number of storage targets may be increased or decreased depending upon e.g., the level of redundancy/performance/capacity required.

Storage system 12 may also include one or more coded targets 110. As is known in the art, a coded target may be used to store coded data that may allow for the regeneration of data lost/corrupted on one or more of storage targets 102, 104, 106, 108. An example of such a coded target may include but is not limited to a hard disk drive that is used to store parity data within a RAID array.

While in this particular example, storage system 12 is shown to include one coded target (e.g., coded target 110), this is for example purposes only and is not intended to be a limitation of this disclosure. Specifically, the actual number of coded targets may be increased or decreased depending upon e.g. the level of redundancy/performance/capacity required.

Examples of storage targets 102, 104, 106, 108 and coded target 110 may include one or more electro-mechanical hard disk drives and/or solid-state/flash devices, wherein a combination of storage targets 102, 104, 106, 108 and coded target 110 and processing/control systems (not shown) may form data array 112.

The manner in which storage system 12 is implemented may vary depending upon e.g. the level of redundancy/performance/capacity required. For example, storage system 12 may be a RAID device in which storage processor 100 is a RAID controller card and storage targets 102, 104, 106, 108 and/or coded target 110 are individual “hot-swappable” hard disk drives. Another example of such a RAID device may include but is not limited to an NAS device. Alternatively, storage system 12 may be configured as a SAN, in which storage processor 100 may be e.g., a server computer and each of storage targets 102, 104, 106, 108 and/or coded target 110 may be a RAID device and/or computer-based hard disk drives. Further still, one or more of storage targets 102, 104, 106, 108 and/or coded target 110 may be a SAN.

In the event that storage system 12 is configured as a SAN, the various components of storage system 12 (e.g. storage processor 100, storage targets 102, 104, 106, 108, and coded target 110) may be coupled using network infrastructure 114, examples of which may include but are not limited to an Ethernet (e.g., Layer 2 or Layer 3) network, a fiber channel network, an InfiniB and network, or any other circuit switched/packet switched network.

Storage system 12 may execute all or a portion of defect identifier generation process 10. The instruction sets and subroutines of defect identifier generation process 10, which may be stored on a storage device (e.g., storage device 16) coupled to storage processor 100, may be executed by one or more processors (not shown) and one or more memory architectures (not shown) included within storage processor 100. Storage device 16 may include but is not limited to: a hard disk drive; a tape drive; an optical drive; a RAID device; a random access memory (RAM); a read-only memory (ROM); and all forms of flash memory storage devices. As discussed above, some portions of the instruction sets and subroutines of defect identifier generation process 10 may be stored on storage devices (and/or executed by processors and memory architectures) that are external to storage system 12.

As discussed above, various IO requests (e.g. IO request 20) may be generated. For example, these IO requests may be sent from client applications 22, 24, 26, 28 to storage system 12. Additionally/alternatively and when storage processor 100 is configured as an application server, these IO requests may be internally generated within storage processor 100. Examples of IO request 20 may include but are not limited to data write request 116 (e.g., a request that content 118 be written to storage system 12) and data read request 120 (i.e. a request that content 118 be read from storage system 12).

During operation of storage processor 100, content 118 to be written to storage system 12 may be processed by storage processor 100. Additionally/alternatively and when storage processor 100 is configured as an application server, content 118 to be written to storage system 12 may be internally generated by storage processor 100.

Storage processor 100 may include frontend cache memory system 122. Examples of frontend cache memory system 122 may include but are not limited to a volatile, solid-state, cache memory system (e.g., a dynamic RAM cache memory system) and/or a non-volatile, solid-state, cache memory system (e.g., a flash-based, cache memory system).

Storage processor 100 may initially store content 118 within frontend cache memory system 122. Depending upon the manner in which frontend cache memory system 122 is configured, storage processor 100 may immediately write content 118 to data array 112 (if frontend cache memory system 122 is configured as a write-through cache) or may subsequently write content 118 to data array 112 (if frontend cache memory system 122 is configured as a write-back cache).

Data array 112 may include backend cache memory system 124. Examples of backend cache memory system 124 may include but are not limited to a volatile, solid-state, cache memory system (e.g., a dynamic RAM cache memory system) and/or a non-volatile, solid-state, cache memory system (e.g., a flash-based, cache memory system). During operation of data array 112, content 118 to be written to data array 112 may be received from storage processor 100. Data array 112 may initially store content 118 within backend cache memory system 124 prior to being stored on e.g. one or more of storage targets 102, 104, 106, 108, and coded target 110.

As discussed above, the instruction sets and subroutines of defect identifier generation process 10, which may be stored on storage device 16 included within storage system 12, may be executed by one or more processors (not shown) and one or more memory architectures (not shown) included within storage system 12. Accordingly, in addition to being executed on storage processor 100, some or all of the instruction sets and subroutines of defect identifier generation process 10 may be executed by one or more processors (not shown) and one or more memory architectures (not shown) included within data array 112.

Further and as discussed above, during the operation of data array 112, content (e.g., content 118) to be written to data array 112 may be received from storage processor 100 and initially stored within backend cache memory system 124 prior to being stored on e.g. one or more of storage targets 102, 104, 106, 108, 110. Accordingly, during use of data array 112, backend cache memory system 124 may be populated (e.g., warmed) and, therefore, subsequent read requests may be satisfied by backend cache memory system 124 (e.g., if the content requested in the read request is present within backend cache memory system 124), thus avoiding the need to obtain the content from storage targets 102, 104, 106, 108, 110 (which would typically be slower).

The Defect Identifier Generation Process:

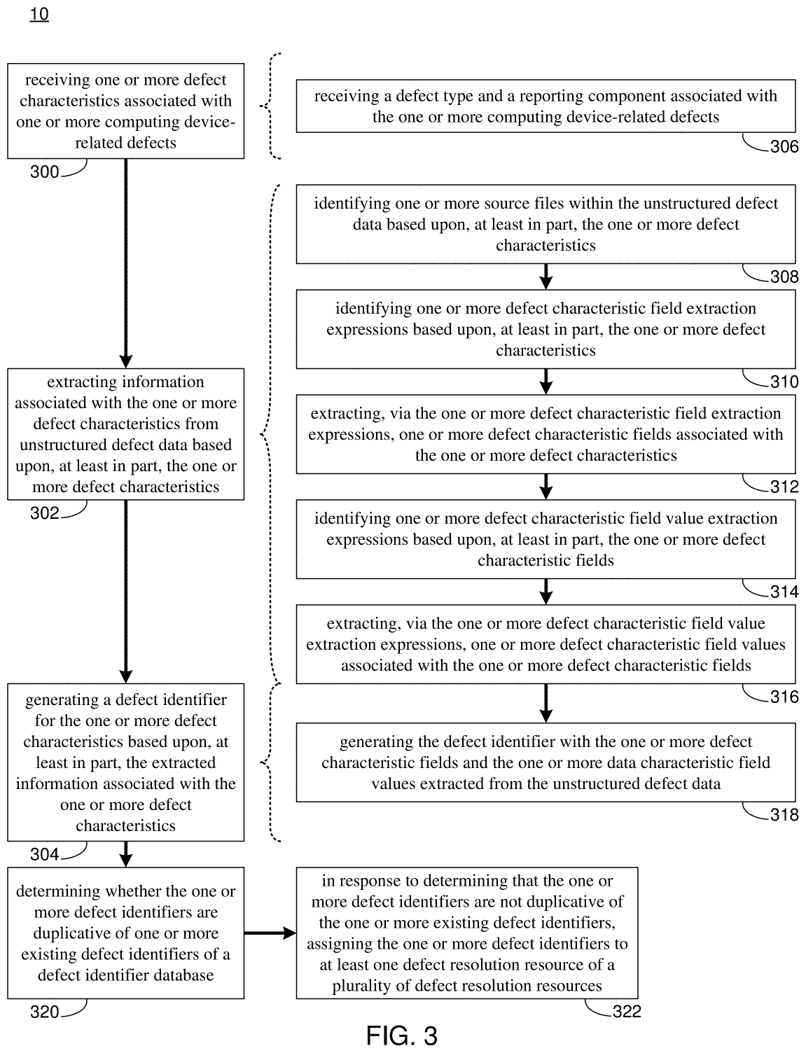

Referring also to the examples of FIGS. 3-5 and in some implementations, defect identifier generation process 10 may receive 300 one or more defect characteristics associated with one or more computing device-related defects. Information associated with the one or more defect characteristics may be extracted 302 from unstructured defect data based upon, at least in part, the one or more defect characteristics. A defect identifier for the one or more defect characteristics may be generated 304 based upon, at least in part, the extracted information associated with the one or more defect characteristics.

As will be discussed in greater detail below, implementations of the present disclosure may allow for the generation of defect or failure identifiers from the largely unstructured defect or failure data received in response to a defect or failure being identified on a storage system or any other computing device. For example, as storage systems are utilized to perform various tasks and operations, software defects and failures may occur. However, diagnosing software failures can be challenging, time consuming, and requires highly skilled engineers whether in-house during product development or triaging a customer issue. When processing these defects, duplicate defects are often found, wasting valuable engineering time triaging the failures. In addition, defects found in the field often affect multiple customers and triaging each issue manually is inefficient. The turnaround time between a defect being discovered and a fix being delivered generally depends on how quickly the defect is provided to the right individuals. Defect data collected from storage systems is largely unstructured, making it difficult to use machine learning techniques and other artificial intelligence techniques to assist in defect identification, de-duplication, and routing of the defect to the right individuals or team.

Accordingly, defect identifier generation process 10 may allow for defect identifiers to be automatically generated from the unstructured defect or failure data received from storage systems and other computing devices. In some implementations and as will be discussed below, defect identifier generation process 10 may determine that newly generated defect identifiers are not duplicates of existing defect identifiers and may automatically assign the defect identifier to a particular defect resolution resource (e.g., individual, team, or system capable of addressing the defect).

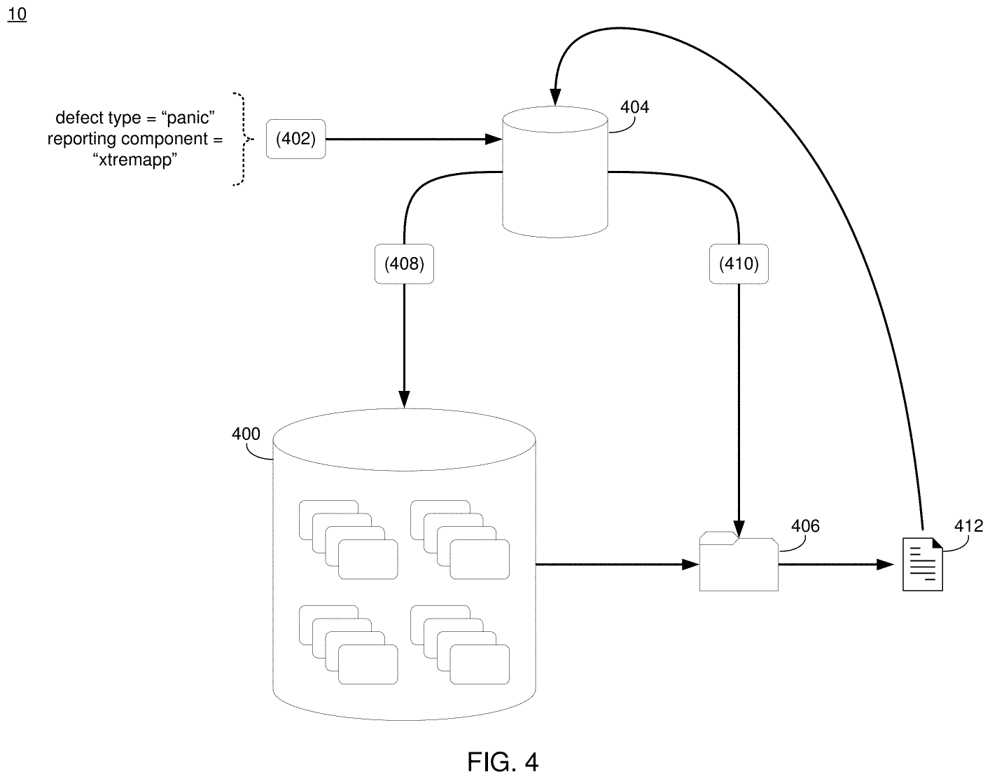

In some implementations and as will be discussed in greater detail below, defect identifier generation process 10 may generate 304 one or more defect identifiers associated with one or more computing device-related defects. A defect identifier may generally include a “footprint” or definition of a particular defect or failure within any hardware and/or software component generated from unstructured defect data. For example and referring also to FIG. 4, within a storage system, various operations may result in errors, failures, and defects in the software of the storage system. In some implementations, computing device-related defects may generally include any defects recorded and/or produced by any hardware and/or software component of a computing device (i.e., defects that are related to the operation of a computing device). In some implementations, a storage system (e.g., storage system 12) may record defect data (e.g., defect data 400) for various purposes (e.g., debugging, triaging, developing, etc.). While an example of defect data associated with a storage system has been described, it will be appreciated that defect identifier generation process 10 may generate one or more defect identifiers for defects recorded or produced by any hardware and/or software component of a computing device or of multiple computing devices, within the scope of the present disclosure.

For example, storage system 12 may be configured to store defect data 400 in a storage device and/or across various storage devices. In some implementations, storage system 12 may provide at least a portion of defect data 400 to one or more external resources. For example, defect data 400 may be provided in response to an application crashing, a storage system going offline, an I/O failure, or other software defect that may be reported to an external resource. Examples of external resources which may receive defect data 400 include storage system administrators, storage system manufacturers, host computing devices coupled to storage system 12, an information technology (IT) group, etc. In this manner, defect data 400 may be processed both at a storage system-level and at various external levels with defect data from a plurality of storage systems.

As discussed above, defect data 400 may be generally unstructured. For example, as various defects, failures, and/or errors are generated and recorded by storage system 12, the defect data generated for each defect may be unique. In one example, a particular application may be programmed to provide certain defect information when e.g., the application crashes. In another example, when a particular component detects a failure in storage system 12, the component (e.g., software and/or hardware module) may be configured to collect and record specific information about the failure. In another example, a storage system vendor may predefine certain failure messages and log information to record when a failure occurs with one of the storage system vendor's components. Accordingly, it will be appreciated that defect data 400 may lack a consistent structure or format. In this manner, processing defect data 400 to identify particular defects using conventional techniques may be ineffective as the format and/or content of defect data 400 may be unstructured (i.e., inconsistent across types of defects, vendor-defined protocols, etc.).

In some implementations, defect identifier generation process 10 may receive 300 one or more defect characteristics associated with one or more computing device-related defects. A defect characteristic may generally include a description or other reference to a description of at least a portion of a computing device-related defect. As will be discussed in greater detail below, example defect characteristics may include a defect type, a reporting component (i.e., the hardware and/or software component that observes and/or reports the defect), an indication of the source of the storage system or other hardware and/or software component where the defect occurs, a timestamp associated with the defect, a list of impacted components or systems, a list of impacted operations of the storage system, etc. While several examples of defect characteristics have been discussed, it will be appreciated that any characteristic or property of a defect may be received 300 within the scope of the present disclosure.

In some implementations, defect identifier generation process 10 may receive 300 the one or more defect characteristics when processing defect data 400. For example, as new defects are added to and/or provided to defect identifier generation process 10, defect identifier generation process 10 may process the defects to determine the one or more defect characteristics for the new defects. In some implementations, defect identifier generation process 10 may receive 300 the one or more defect characteristics by selection of specific defect characteristics. For example, defect identifier generation process 10 may provide options (e.g., via a user interface) for providing a selection of particular defect characteristics to use to generate defect identifiers. In some implementations, defect identifier generation process 10 may automatically process a list of defect characteristics to generate defect identifiers.

In some implementations, receiving 300 the one or more defect characteristics may include receiving 306 a defect type and a reporting component associated with the one or more computing device-related defects. For example, defect identifier generation process 10 may organize defects by defect type and/or a component (e.g., hardware and/or software module) that reports the defect. As discussed above and in some implementations, the type of defect and/or reporting component may help distinguish one defect from another.

Referring again to the example of FIG. 4, defect identifier generation process 10 may receive a particular defect from defect data. In some implementations, defect identifier generation process 10 may automatically process defect data 400 as new defect data is added to generate 304 a defect identifier for the new defect data. In some implementations, defect identifier generation process 10 may receive a selection (e.g., via a user interface) of defect data for generating a defect identifier. For example, suppose a defect occurs during the operation of storage system 12. Defect identifier generation process 10 may receive (e.g., automatically and/or manually via a selection of the defect) the defect (e.g., defect 402) and may generate 304 a defect identifier for the defect by determining a defect type and a reporting component associated with the defect. In some implementations, defect identifier generation process 10 may extract the defect type and/or the reporting component from defect 402.

In one example, suppose that defect 402 pertains to a “panic” failure (e.g., storage system 12 experienced a “panic” failure) that was reported by the “xtremapp” component. In this example, defect identifier generation process 10 may determine that the defect type for defect 402 is “panic” and that the reporting component is “xtremapp”. While a specific example of a defect type and a reporting component has been described, it will be appreciated that these are for example purposes only and that any defect type and/or reporting component may be determined for any defect within the scope of the present disclosure.

In some implementations, defect identifier generation process 10 may extract 302 information associated with the one or more defect characteristics from unstructured defect data based upon, at least in part, the one or more defect characteristics. Returning to the above example with defect 402 that pertains to a “panic” failure that was reported by the “xtremapp” component, defect identifier generation process 10 may extract 302 information associated with the defect characteristics (e.g., “panic” defect type and “xtremapp” reporting component) from unstructured defect data 400.

In some implementations, extracting 302 the information associated with the one or more defect characteristics from the unstructured defect data may include identifying 308 one or more source files within the unstructured defect data based upon, at least in part, the one or more defect characteristics. Referring again to FIG. 4 and in some implementations, defect identifier generation process 10 may use the one or more defect characteristics to query a database (e.g., database 404) for source files within unstructured defect data 400 that are associated with the one or more defect characteristics. Returning to the above example with a defect type of “panic” and a reporting component of “xtremapp”, defect identifier generation process 10 may provide the defect characteristics in one or more queries to database 404 to identify 308 one or more source files within unstructured defect data 400.

In some implementations, database 404 may represent a single database, a distributed database, multiple databases, or any combination thereof, that is/are configured to store predefined information associated with particular defect characteristics. For example, database 404 may include a plurality of extraction expressions for obtaining information associated with defect characteristics from unstructured defect data 400. In some implementations, the entries of database 404 may include pairings of defect characteristics and location information or expressions to execute on unstructured defect data 400 to identify 308 one or more source files associated with the defect characteristics.

In some implementations, extracting 302 the information associated with the one or more defect characteristics from the unstructured defect data may include identifying 310 one or more defect characteristic field extraction expressions based upon, at least in part, the one or more defect characteristics. A defect characteristic field extraction expression may generally include an expression to execute on unstructured defect data to return one or more fields associated with a particular defect characteristic. An example of the defect characteristic field extraction expression may include, but is not limited to, a regular expression. As is known in the art, a regular expression generally includes a sequence of characters that specifies a search pattern. While an example of a regular expression has been provided, it will be appreciated that the one or more defect characteristic field extraction expressions may include any expression configured to extract one or more fields from unstructured defect data.

Referring again to the example of FIG. 4 and in some implementations, defect identifier generation process 10 may use the one or more defect characteristics to query a database (e.g., database 404) for defect characteristic field extraction expressions within unstructured defect data 400 that are associated with the one or more defect characteristics. Returning to the above example with a defect type of “panic” and a reporting component of “xtremapp”, defect identifier generation process 10 may provide defect characteristics 402 in one or more queries to database 404 to identify 310 one or more defect characteristic field extraction expressions associated with the defect characteristics from within the unstructured defect data. In some implementations, entries of database 404 may include pairings of defect characteristics and data characteristic field extraction expressions to execute on unstructured defect data 400 to identify 310 one or more fields associated with the one or more defect characteristics. In some implementations, defect identifier generation process 10 may allow the data characteristic field extraction expressions within database 404 to be added, removed, and/or updated (e.g., via a user interface).

In some implementations, defect identifier generation process 10 may identify 308 the one or more source files to execute the one or more data characteristic field extraction expressions on. For example, suppose that defect identifier generation process 10 identifies 308 a source file (e.g., source file 406) from unstructured defect data 400 based upon, at least in part, the “panic” defect type and “xtremapp” reporting component defect characteristics (e.g., one or more queries to database 404). In this example, suppose that defect identifier generation process 10 identifies one or more data characteristic field extraction expressions (e.g., data characteristic field extraction expressions 408) associated with the “panic” defect type and/or “xtremapp” reporting component defect characteristics. Defect identifier generation process 10 may execute the identified one or more data characteristic field extraction expressions on the one or more source files (e.g., source file 406) to obtain one or more data characteristic fields associated with the “panic” defect type and/or “xtremapp” reporting component defect characteristics.

In this manner and as will be discussed in greater detail below, the data characteristic field extraction expressions may identify the fields to populate to generate a defect identifier for particular defect characteristics. Accordingly, defect identifier generation process 10 may provide extraction expressions that identify what information to extract and where to extract the information from within unstructured defect data 400 for specified defect characteristics. While an example of one source file (e.g., source file 406) has been discussed, it will be appreciated that defect identifier generation process 10 may identify 308 any number of source files from the unstructured defect data within the scope of the present disclosure.

Referring to the example of Tables 1-2 below, defect identifier generation process 10 may extract one or more source files and one or more data characteristic field extraction expressions associated with the “panic” defect type and the “xtremapp” reporting component.

TABLE 1

| Type | Source | Type Extraction Expression |
|---|---|---|
| panic | \hat{ }[a-zA-Z](.*...) | (?<=Type...) |

TABLE 2

| | | Component Extraction |
|---|---|---|
| Component | Source | Expression |
| xtremapp | \hat{ }[a-zA-Z](.*...) | (?<=Executable...) |

In some implementations, extracting 302 the information associated with the one or more defect characteristics from the unstructured defect data may include extracting 312, via the one or more defect characteristic field extraction expressions, one or more defect characteristic fields associated with the one or more defect characteristics. Returning to the above example and in some implementations, defect identifier generation process 10 may return one or more expressions to execute on unstructured defect data 400 to identify 308 one or more source files associated with the one or more defect characteristics (e.g., source files associated with the “panic” defect type and/or the “xtremapp” reporting component). Additionally, defect identifier generation process 10 may identify 310 one or more defect characteristic field extraction expressions (e.g., defect characteristic field extraction expressions 408) for identifying one or more fields associated with the one or more defect characteristics (e.g., fields associated with the “panic” defect type and/or the “xtremapp” reporting component). Referring again to the example of FIG. 4 and in some implementations, defect identifier generation process 10 may identify 310 one or defect characteristic field extraction expressions (e.g., defect characteristic field extraction expressions 408) from database 404 and/or unstructured data 400. Defect identifier generation process 10 may identify 310 one or more data characteristic field extraction expressions to execute on unstructured defect data 400 and/or source file 406 to determine which fields to populate for the “panic” defect type and/or the “xtremapp” reporting component defect characteristics.

In some implementations, extracting 302 the information associated with the one or more defect characteristics from the unstructured defect data may include identifying 314 one or more defect characteristic field value extraction expressions based upon, at least in part, the one or more defect characteristic fields. A defect characteristic field value extraction expression may generally include an expression configured to return a value associated with a particular defect characteristic field. As discussed above, with the one or more data characteristic field extraction expressions, defect identifier generation process 10 may extract 312 one or more fields associated with specific defect characteristics.

In some implementations, defect identifier generation process 10 may use the one or more defect characteristics to query a database (e.g., database 404) for defect characteristic field value extraction expressions that are associated with the one or more defect characteristics. Returning to the above example with a defect type of “panic” and a reporting component of “xtremapp”, defect identifier generation process 10 may provide the defect characteristics in one or more queries to database 404 to identify 314 one or more defect characteristic field value extraction expressions (e.g., defect characteristic field value extraction expressions 410) associated with the defect characteristics from within the unstructured defect data.

Referring again to the example of FIG. 4 and in some implementations, defect identifier generation process 10 may identify 314 one or more data characteristic field value extraction expressions to execute on source file 406 to populate the extracted fields for the “panic” defect type and/or the “xtremapp” reporting component defect characteristics. As shown below in Table 3, defect identifier generation process 10 may identify 314 one or more defect characteristic fields and one or more defect characteristic field value extraction expressions.

TABLE 3

| | | | Field Extraction |
|---|---|---|---|
| Component | Field | Source | Expression |
| xtremapp | Assertion | \hat{ }[a-zA-Z](.*....) | (((?<=msg...) |
| | Function | \hat{ }[a-zA-Z](.*....) | (?s)((?<=...) |
| | CSID | \hat{ }[a-zA-Z](.*....) | (?<=CSID...) |
| | Backtrace | \hat{ }[a-zA-Z](.*....) | (?s)((?<=...) |

In some implementations, extracting 302 the information associated with the one or more defect characteristics from the unstructured defect data may include extracting 316, via the one or more defect characteristic field value extraction expressions, one or more defect characteristic field values associated with the one or more defect characteristic fields. Returning to the above example and in some implementations, defect identifier generation process 10 may identify 314 defect characteristic field value extraction expressions 410 associated with the “panic” defect type and/or the “xtremapp” reporting component defect characteristics. In this example, defect identifier generation process 10 may extract 316, via defect characteristic field value extraction expressions 410, one or more defect characteristic field values associated with the one or more defect characteristic fields (e.g., the “panic” defect type and/or the “xtremapp” reporting component defect characteristics).

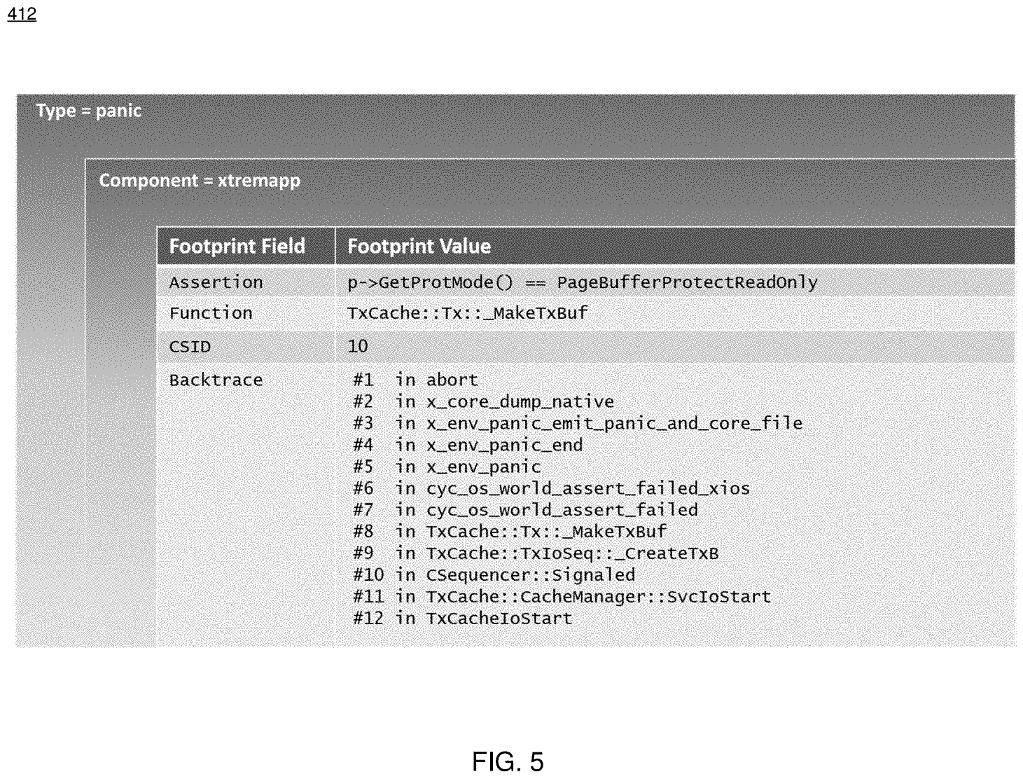

In some implementations, defect identifier generation process 10 may generate 304 a defect identifier for the one or more defect characteristics based upon, at least in part, the extracted information associated with the one or more defect characteristics. As discussed above and in some implementations, a defect identifier (e.g., defect identifier 412) may include a description of particular defect and may include information from unstructured defect data to identify the cause and/or how to address the defect. Referring also to FIG. 5 and in some implementations, defect identifier generation process 10 may generate 304 a defect identifier (e.g., defect identifier 412) for the one or more defect characteristics (e.g., the defect type of “panic” and the reporting component of “xtremapp”) based upon, at least in part, the extracted information associated with the one or more defect characteristics.

In some implementations, generating 304 the defect identifier for the one or more defect characteristics may include generating 318 the defect identifier with the one or more defect characteristic fields and the one or more data characteristic field values extracted from the unstructured defect data. Referring again to FIG. 5 and as discussed above, defect identifier generation process 10 may generate 318 defect identifier 412 by populating the one or more defect characteristic fields with the one or more data characteristic field values extracted from source file 406. While source file 406 is described in this example as a single file, it will be appreciated that the one or more data characteristic field values may be extracted from any number of source files identified 308 by defect identifier generation process 10 within the scope of the present disclosure.

In some implementations, in response to generating 308 defect identifier 412, defect identifier generation process 10 may store defect identifier 412 in a defect identifier database. As will be discussed in greater detail below, defect identifier generation process 10 may determine whether to perform one or more actions (e.g., a de-duplication action, an assignment action, etc.) on defect identifier 412 after storing defect identifier 412 within the defect identifier database. In one example, defect identifier database may be included within database 404. For example, defect identifier database may be a subset of database 404. In another example, the defect identifier database may be separate from database 404. Accordingly, it will be appreciated that the defect identifier database may include any database or portion of a database within the scope of the present disclosure.

In some implementations, defect identifier generation process 10 may determine 320 whether the one or more defect identifiers are duplicative of one or more existing defect identifiers of the defect identifier database. For example, defect identifier generation process 10 may determine 320 whether the one or more defect identifiers (e.g., defect identifier 412) are duplicative of an existing defect identifier by utilizing a weighted similarity algorithm on the newly generated defect identifier and comparing it against the collection of defect footprints for the same defect characteristics (e.g., defect type, reporting component, etc.) stored in a defect identifier database.

In one example, defect identifier generation process 10 may determine 320 whether the one or more defect identifiers are duplicative of one or more existing defect identifiers of a defect identifier database with e.g., a weighted dice coefficient algorithm to generate a similarity score between defect identifiers. However, it will be appreciated that any algorithm or process for comparing datasets may be used to determine 320 whether the one or more defect identifiers are duplicative of one or more existing defect identifiers within the scope of the present disclosure.

In some implementations, defect identifier generation process 10 may compare defect identifier fields for similarity using a field threshold (e.g., 0-100%) to mark how much that field must match in order to consider a defect identifier as a duplicate. In some implementations, the field threshold may be a predefined value. For example, the field threshold may be received (e.g., via a user interface) and/or may be determined automatically by defect identifier generation process 10. In some implementations, a defect identifier that does not meet the field threshold match may be discarded from the comparison (i.e., the defect identifier is not a duplicate). Defect identifier generation process 10 may multiply the defect identifier field similarity scores by various weights to generate a weighted similarity score. The weighted similarity scores may be summed to generate a match threshold value (e.g., between 0-100%). In some implementations, if a match threshold percentage is met, a duplicate recommendation or an auto-duplicate service may be performed (e.g., to remove an older version of the duplicate defect identifier, to preserve the original defect identifier, etc.)In some implementations, the match threshold may be a predefined value. For example, the match threshold may be received (e.g., via a user interface) and/or may be determined automatically by defect identifier generation process 10.

In some implementations and in response to determining that the one or more defect identifiers are not duplicative of the one or more existing defect identifiers, defect identifier generation process 10 may assign 322 the one or more defect identifiers to at least one defect resolution resource of a plurality of defect resolution resources. For example, defect identifier generation process 10 may assign 322 the defect identifier (e.g., defect identifier 412) to a defect resolution resource. In some implementations, a defect resolution resource may generally include any individual, team, automated system, etc. configured to process and resolve defects within a storage system or any other computing device using defect identifiers.

In some implementations, assigning 322 the one or more defect identifiers to the at least one defect resolution resource of a plurality of defect resolution resources may include identifying a defect resolution resource from the plurality of defect resolution resources based upon, at least in part, one or more assignment rules and the one or more defect identifiers. For example, a defect identifier may be assigned 322 to a particular resolution resource by running assignment rules against the defect identifier to determine whether the defect identifier matches an assignment rule. If a match is found, defect identifier generation process 10 may assign 322 the defect to the defect resolution resource defined in the rule. If no match is found, the defect identifier may be assigned to a predefined default defect resolution resource. In some implementations, the one or more assignment rules may be predefined, manually defined (e.g., via a user interface), and/or may be defined automatically (e.g., via defect identifier generation process 10).

In some implementations of the present disclosure, it has been observed that software defects have been processed more quickly and more efficiently than when using conventional and manual defect identification processes and techniques by generating defect identifiers from information extracted from unstructured defect data using defect characteristics.

### General:

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object oriented programming language such as Java, Smalltalk, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet (e.g., network 14).

The present disclosure is described with reference to flowchart illustrations and/or block diagrams of methods, apparatus (systems) and computer program products according to implementations of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer/special purpose computer/other programmable data processing apparatus, such that the instructions, which execute via the processor of the computer or other programmable data processing apparatus, create means for implementing the functions/acts specified in the flowchart and/or block diagram block or blocks.

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various implementations of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular implementations only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various implementations with various modifications as are suited to the particular use contemplated.

A number of implementations have been described. Having thus described the disclosure of the present application in detail and by reference to implementations thereof, it will be apparent that modifications and variations are possible without departing from the scope of the disclosure defined in the appended claims.

What is claimed is:

1. A computer-implemented method, executed on a computing device, comprising:
receiving one or more defect characteristics associated with one or more computing device-related defects;
extracting information associated with the one or more defect characteristics from unstructured defect data based upon, at least in part, the one or more defect characteristics; and
generating a defect identifier for the one or more defect characteristics based upon, at least in part, the extracted information associated with the one or more defect characteristics.

2. The computer-implemented method of claim 1, wherein receiving the one or more defect characteristics include receiving a defect type and a reporting component associated with the one or more computing device-related defects.

3. The computer-implemented method of claim 1, wherein extracting the information associated with the one or more defect characteristics from the unstructured defect data includes:
identifying one or more source files within the unstructured defect data based upon, at least in part, the one or more defect characteristics;
identifying one or more defect characteristic field extraction expressions based upon, at least in part, the one or more defect characteristics; and
extracting, via the one or more defect characteristic field extraction expressions, one or more defect characteristic fields associated with the one or more defect characteristics.

4. The computer-implemented method of claim 3, wherein extracting the information associated with the one or more defect characteristics from the unstructured defect data includes:
identifying one or more defect characteristic field value extraction expressions based upon, at least in part, the one or more defect characteristic fields; and
extracting, via the one or more defect characteristic field value extraction expressions, one or more defect characteristic field values associated with the one or more defect characteristic fields.

5. The computer-implemented method of claim 4, wherein generating the defect identifier for the one or more defect characteristics includes generating the defect identifier with the one or more defect characteristic fields and the one or more data characteristic field values extracted from the unstructured defect data.

6. The computer-implemented method of claim 1, further comprising:
determining whether the one or more defect identifiers are duplicative of one or more existing defect identifiers of a defect identifier database.

7. The computer-implemented method of claim 6, further comprising:
in response to determining that the one or more defect identifiers are not duplicative of the one or more existing defect identifiers, assigning the one or more defect identifiers to at least one defect resolution resource of a plurality of defect resolution resources.

8. A computer program product residing on a non-transitory computer readable medium having a plurality of instructions stored thereon which, when executed by a processor, cause the processor to perform operations comprising:
receiving one or more defect characteristics associated with one or more computing device-related defects;
extracting information associated with the one or more defect characteristics from unstructured defect data based upon, at least in part, the one or more defect characteristics; and
generating a defect identifier for the one or more defect characteristics based upon, at least in part, the extracted information associated with the one or more defect characteristics.

9. The computer program product of claim 8, wherein receiving the one or more defect characteristics include receiving a defect type and a reporting component associated with the one or more computing device-related defects.

10. The computer program product of claim 8, wherein extracting the information associated with the one or more defect characteristics from the unstructured defect data includes:
identifying one or more source files within the unstructured defect data based upon, at least in part, the one or more defect characteristics;
identifying one or more defect characteristic field extraction expressions based upon, at least in part, the one or more defect characteristics; and
extracting, via the one or more defect characteristic field extraction expressions, one or more defect characteristic fields associated with the one or more defect characteristics.

11. The computer program product of claim 10, wherein extracting the information associated with the one or more defect characteristics from the unstructured defect data includes:
identifying one or more defect characteristic field value extraction expressions based upon, at least in part, the one or more defect characteristic fields; and
extracting, via the one or more defect characteristic field value extraction expressions, one or more defect characteristic field values associated with the one or more defect characteristic fields.

12. The computer program product of claim 11, wherein generating the defect identifier for the one or more defect characteristics includes generating the defect identifier with the one or more defect characteristic fields and the one or more data characteristic field values extracted from the unstructured defect data.

13. The computer program product of claim 8, wherein the operations further comprise:
determining whether the one or more defect identifiers are duplicative of one or more existing defect identifiers of a defect identifier database

14. The computer program product of claim 13, wherein the operations further comprise:
in response to determining that the one or more defect identifiers are not duplicative of the one or more existing defect identifiers, assigning the one or more defect identifiers to at least one defect resolution resource of a plurality of defect resolution resources.

15. A computing system comprising:
a memory; and
a processor configured to receive one or more defect characteristics associated with one or more computing device-related defects, wherein the processor is further configured to extract information associated with the one or more defect characteristics from unstructured defect data based upon, at least in part, the one or more defect characteristics, and wherein the processor is further configured to generate a defect identifier for the one or more defect characteristics based upon, at least in part, the extracted information associated with the one or more defect characteristics.

16. The computing system of claim 15, wherein receiving the one or more defect characteristics include receiving a defect type and a reporting component associated with the one or more computing device-related defects.

17. The computing system of claim 15, wherein extracting the information associated with the one or more defect characteristics from the unstructured defect data includes:
identifying one or more source files within the unstructured defect data based upon, at least in part, the one or more defect characteristics;
identifying one or more defect characteristic field extraction expressions based upon, at least in part, the one or more defect characteristics; and
extracting, via the one or more defect characteristic field extraction expressions, one or more defect characteristic fields associated with the one or more defect characteristics.

18. The computing system of claim 17, wherein extracting the information associated with the one or more defect characteristics from the unstructured defect data includes:
identifying one or more defect characteristic field value extraction expressions based upon, at least in part, the one or more defect characteristic fields; and
extracting, via the one or more defect characteristic field value extraction expressions, one or more defect characteristic field values associated with the one or more defect characteristic fields.

19. The computing system of claim 18, wherein generating the defect identifier for the one or more defect characteristics includes generating the defect identifier with the one or more defect characteristic fields and the one or more data characteristic field values extracted from the unstructured defect data.

20. The computing system of claim 15, wherein the processor is further configured to:
determine whether the one or more defect identifiers are duplicative of one or more existing defect identifiers of a defect identifier database.
